(19) United States
(12) Patent Application Publication
(10) Pub. No.: US 2026/0362067 A1
(43) Pub. Date: Nov. 12, 2026

(54) HEARING DEVICE WITH GAINS BASED ON BINAURAL BEAMFORMING

(71) Applicant: GN Hearing A/S, Ballerup (DK)

(72) Inventors: Changxue MA, Barrington, IL (US); Rob Anton Jurjen DE VRIES, Tilburg (NL)

(73) Assignee: GN Hearing A/S, Ballerup (DK)

(21) Appl. No.: 19/201,306

(22) Filed: May 7, 2025

(51) Int. Cl. H04R 25/00

(52) U.S. Cl. CPC H04R 25/505

(57) ABSTRACT

A hearing device includes: a transceiver module for communication with a contralateral hearing device, the transceiver module configured to receive contralateral data comprising a contralateral input signal; a set of microphones; a binaural beamformer configured to provide a binaural beamform signal based on a microphone input signal and the contralateral input signal; a processor configured to provide an electrical output signal; and a receiver configured to provide an audio output signal based on the electrical output signal; wherein the processor comprises: a power estimator for provision of a maximum power that is a maximum of (1) a power of the contralateral input signal and (2) a power of the microphone input signal; and a gain estimator for provision of a binaural gain based on the binaural beamform signal and the maximum power; and wherein the electrical output signal is based on the binaural gain.

### FIELD

The present disclosure relates to a hearing device for a binaural hearing system and related methods including a method of operating a hearing device.

### BACKGROUND

People with a hearing loss often experience difficulties understanding speech in noisy environments. Listening devices, including hearing devices with compensation for a hearing loss, with directional sound capture, such as with spatial filtering, can be an option to improve intelligibility of speech in noisy environments, such as to improve signal-to-noise ratio (SNR). Use of directional microphones including beamforming methods involving multiple microphones and arrays of multiple microphones on both sides of a user in an ipsilateral hearing device also denoted first hearing device and in a contralateral device also denoted second hearing device can be an option to obtain directional sound capture. Beamforming microphone arrays in listening devices can improve the SNR and thus enhancing speech intelligibility. Challenges still remain in recovering and maintaining binaural cues of sound sources, which is very important to optimize source segregations and auditory attention.

### SUMMARY

Accordingly, there is a need for hearing devices and methods with improved spatial cueing of sound sources.

Disclosed is a hearing device for a binaural hearing system. The hearing device comprises a transceiver module for communication with a contralateral hearing device of the binaural system, the transceiver module configured to receive contralateral data from the contralateral hearing device, the contralateral data comprising a contralateral input signal; a set of microphones for provision of a microphone input signal, such as a first microphone input signal from a first microphone and/or a beamform microphone input signal; a binaural beamformer, e.g. connected to the set of microphones and/or the transceiver module, for provision of a binaural beamform signal, e.g. based on the microphone input signal and/or the contralateral input signal; a processor configured to provide an electrical output signal based on the microphone input signal and/or the binaural beamform signal; and a receiver for converting the electrical output signal to an audio output signal. The processor comprises a power estimator, e.g. for provision of a maximum power of a power of the contralateral input signal and the microphone input signal, and a gain estimator, e.g. for provision of a binaural gain based on the binaural beamform signal and the maximum power. The electrical output signal may be based on one or more gains, such as the binaural gain.

A method of operating a hearing device for a binaural hearing system comprising the hearing device and a contralateral hearing device is disclosed, the method comprising receiving contralateral data from the contralateral hearing device, the contralateral data comprising a contralateral input signal; providing, e.g. from a set of microphones of the hearing device and optionally via a pre-processor, a microphone input signal and optionally a secondary microphone input signal; providing, with a binaural beamformer of the hearing device, a binaural beamform signal based on the microphone input signal and the contralateral input signal; processing the microphone input signal and the binaural beamform signal for provision of an electrical output signal; and converting the electrical output signal to an audio output signal, wherein processing the microphone input signal and the binaural beamform signal comprises estimating a power, such as a maximum power of a power of the contralateral input signal and the microphone input signal; providing a binaural gain based on the binaural beamform signal and the power, such as the maximum power; and providing the electrical output signal based on the binaural gain, e.g. by processing the microphone input signal or the secondary microphone input signal based on the binaural gain.

Also, a binaural hearing system is disclosed, the binaural hearing system comprising a first hearing device and a second hearing device, wherein the first hearing device is a hearing device as disclosed herein and the second hearing device is a hearing device as disclosed herein.

The present disclosure allows for reduced or no ILD distortion in turn leading to improved spatial perception and discrimination of sound sources associated with different spatial locations. Improved speech intelligibility in noisy environments is provided.

The present disclosure allows for computation of instantaneous or real-time gain function from the binaural beamform signal. The hearing compensation, such as one or more filters and/or compressors/compressor circuitry, receive the same gain function in both hearing devices therefore not generate extra ILD for the electrical output signals.

The present disclosure allows for improved preservation of the ILDs and/or ITDs in the hearing device. In other words, a hearing device having binaural beamforming with reduced ILD and/or ITD distortion is provided.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 schematically illustrates an example hearing device according to this disclosure,

FIG. 2 schematically illustrates an example hearing device according to this disclosure, and

FIG. 3 schematically illustrates an example method according to this disclosure.

### DETAILED DESCRIPTION

Various exemplary embodiments and details are described hereinafter, with reference to the figures when relevant. It should be noted that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A hearing device also denoted first hearing device and/or second hearing device is disclosed, e.g. a hearing device for a binaural hearing system. The hearing device may be configured to be worn at an ear of a user and may be a hearable or a hearing aid, wherein the processor is configured to compensate for a hearing loss of a user. In other words, processing the microphone input signal or secondary microphone input signal may comprise applying hearing compensation to the microphone input signal/secondary microphone input signal for provision of a hearing-compensated electrical output signal.

The hearing device may be of the behind-the-ear (BTE) type, in-the-ear (ITE) type, in-the-canal (ITC) type, receiver-in-canal (RIC) type, receiver-in-the-ear (RITE) type, or microphone-in-ear (MIE) type. The hearing aid may be a binaural hearing aid. The hearing device may comprise a first earpiece and a second earpiece, wherein the first earpiece and/or the second earpiece is an earpiece as disclosed herein.

The hearing device comprises a transceiver module for communication with a contralateral hearing device, also denoted second hearing device, of the binaural system. The transceiver module is configured to receive contralateral data from the contralateral hearing device and/or transmit ipsilateral data to the contralateral hearing device. The contralateral data optionally comprises and/or is representative of a contralateral input signal. In one or more example hearing devices, the contralateral data comprises a directional contralateral input signal or spectrum also denoted FR. In other words, the contralateral data is optionally representative of the directional contralateral input signal.

Thus, the hearing device may be configured for wireless communication with one or more devices, such as with a contralateral hearing device, e.g. as part of a binaural hearing system, and/or with one or more accessory devices, such as a smartphone and/or a smart watch. The hearing device, such as the transceiver module, optionally comprises an antenna for converting one or more wireless input signals, such as a contralateral input signal from a contralateral hearing device, to antenna output signal(s). The wireless input signal(s) may origin from external source(s), such as spouse microphone device(s), wireless TV audio transmitter, and/or a distributed microphone array associated with a wireless transmitter. The wireless input signal(s) may origin from a contralateral hearing device, e.g. as part of a binaural hearing system, and/or from one or more accessory devices.

The hearing device, such as the transceiver module, optionally comprises a radio transceiver coupled to the antenna for converting the antenna output signal to a transceiver input signal. Wireless signals from different external sources may be multiplexed in the radio transceiver to a transceiver input signal or provided as separate transceiver input signals on separate transceiver output terminals of the radio transceiver. The hearing device, such as the transceiver module, may comprise a plurality of antennas and/or an antenna may be configured to be operate in one or a plurality of antenna modes. The transceiver input signal optionally comprises a first transceiver input signal representative of the contralateral input signal from the contralateral hearing device.

The hearing device comprises a set of microphones for provision of a microphone input signal. The set of microphones may comprise one or more microphones. The set of microphones comprises a first microphone, e.g. a first BTE microphone or a MIE microphone, for provision of a first microphone input signal, e.g. a first BTE microphone input signal or a MIE microphone input signal as the first microphone input signal. The first BTE (Behind-The-Ear) microphone is arranged in a BTE housing of the hearing device configured to be arranged behind the ear of a user. The set of microphones comprises a second microphone, e.g. a second BTE microphone or a MIE microphone, for provision of a second microphone input signal, e.g. a second BTE microphone input signal or a MIE microphone input signal. The second BTE (Behind-The-Ear) microphone is optionally arranged in the BTE housing configured to be arranged behind the ear of a user. The MIE microphone is arranged near, at or in the ear canal of the user, e.g. in an earpiece connected by wire to a BTE housing. The set of microphones optionally comprises a third microphone, e.g. a MIE microphone when the second microphone is a second BTE microphone, for provision of a third microphone input signal, e.g. a MIE microphone input signal. A MIE (Microphone-In-Ear) microphone is arranged near, at or in the ear canal of the user, e.g. in an earpiece optionally connected by wire to a BTE housing. The set of microphones may comprise N microphones for provision of N microphone signals, wherein N is an integer in the range from 1 to 10. In one or more example hearing devices, the number N of microphones is two, three, four, five or more. The microphone input signal also denoted FL may be a directional input signal. In other words, the microphone input signal may be a beamformed microphone input signal, where beamforming is applied to two microphone input signals, such as the first microphone input signal, e.g. from a first BTE microphone, and the second microphone input signal, e.g. from a second BTE microphone. In one or more examples, the third microphone input signal, such as a MIE microphone input signal may be used as, form basis for, or constitute the microphone input signal. The microphone input signal may be based on one or more of a first microphone input signal from a first microphone, a second microphone input signal from a second microphone, and a third microphone input signal from a third microphone.

The transceiver module is configured to transmit ipsilateral data to the contralateral hearing device. The ipsilateral data optionally comprises and/or is representative of the microphone input signal. In one or more example hearing devices, the ipsilateral data/microphone input signal comprises a directional microphone input signal or spectrum also denoted FL. In other words, the ipsilateral data is optionally representative of the directional microphone input signal.

The hearing device comprises a binaural beamformer connected to the set of microphones, e.g. via a pre-processor, and the transceiver module for provision of a binaural beamform signal based on the microphone input signal and the contralateral input signal. In other words, the microphone input signal and the contralateral input signal are fed or input to the binaural beamformer, and the binaural beamformer is configured to apply beamforming to the microphone input signal and the contralateral input signal and output the resulting binaural beamform signal. The binaural beamformer may be implemented in the processor or in separate circuitry as described herein. The binaural beamformer may be an adaptive beamformer. The binaural beamformer may be a multi-bin beamformer. In other words, the binaural beamformer may perform bin-specific beamforming to a plurality of frequency bins of the microphone input signal and the contralateral input signal.

A beamformer performs beamforming or spatial filtering based on two or more input signals, such as a first microphone input signal and a second microphone input signal.

A binaural beamformer is a beamformer that applies beamforming to input signals from both hearing devices in a binaural hearing system.

A binaural gain is a gain dependent on input signals from both hearing devices in a binaural hearing system.

The hearing device comprises a processor configured to provide an electrical output signal based on the microphone input signal and optionally the binaural beamform signal. Thus, the hearing device comprises a processor for processing input signals, such as the microphone input signal and/or the binaural beamform signal. The processor is optionally configured to compensate for hearing loss of a user of the hearing device. The processor is optionally configured to provide an electrical output signal based on a secondary microphone input signal, e.g. different from the microphone input signal fed or input to the binaural beamformer. It is understood that the processor may be a distributed processor, where processing tasks may be distributed to a plurality of processors.

The hearing device comprises a receiver for converting the electrical output signal to an audio output signal.

The processor, such as a gain controller of the processor, may comprise one or more power estimators for estimating respective one or more powers of input signal(s), such as a power estimator for provision of a maximum power of a power of the contralateral input signal and the microphone input signal. The power estimator for provision of a maximum power of a power of the contralateral input signal and the microphone input signal is also denoted first power estimator, and a maximum power of a power of the contralateral input signal and the microphone input signal is also denoted first power.

The processor, such as a gain controller of the processor, may comprise one or more gain estimators for provision of respective one or more gains, such as a gain estimator also denoted first gain estimator for provision of a binaural gain based on the binaural beamform signal and the maximum power. The electrical output signal is optionally based on the binaural gain. In other words, processing, such as hearing compensation including compression and/or filtering, of the microphone input signal or the secondary microphone input signal may be controlled based on the binaural gain. The binaural gain is also denoted first gain. The gain controller may be configured to output a control signal representative of or based on the binaural gain. Thus, hearing compensation circuitry, such as compressor circuitry and/or filter coefficients, configured to process the microphone input signal or secondary microphone inputs signal for provision of the electrical output signal may be adjusted according to the control signal from the gain controller such that the electrical output signal is based on the binaural gain.

In one or more examples, a hearing device for a binaural hearing system is disclosed, the hearing device comprising a transceiver module for communication with a contralateral hearing device of the binaural system, the transceiver module configured to receive contralateral data from the contralateral hearing device, the contralateral data comprising a contralateral input signal; a set of microphones for provision of a microphone input signal; a binaural beamformer connected to the set of microphones and the transceiver module for provision of a binaural beamform signal based on the microphone input signal and the contralateral input signal; a processor configured to provide an electrical output signal based on the microphone input signal and the binaural beamform signal; and a receiver for converting the electrical output signal to an audio output signal, wherein the processor comprises a power estimator for provision of a maximum power of a power of the contralateral input signal and the microphone input signal; and a gain estimator for provision of a binaural gain based on the binaural beamform signal and the maximum power, wherein the electrical output signal is based on the binaural gain.

The binaural gain may be based on magnitude or absolute value of the binaural beamform signal. The binaural gain may be based on a power, such as a maximum, averaged, or minimum power, of the contralateral input signal and the microphone input signal. The binaural gain may be determined as a ratio or difference. The binaural gain may be based on a power, such as a maximum, averaged, or minimum power, of the contralateral input signal and the microphone input signal. In one or more examples, the binaural gain is based on a third microphone input signal from a third microphone of the set of microphones, the third microphone being a MIE microphone. In other words, the binaural gain may be based on a microphone input signal from a MIE microphone. The contralateral input signal may be from a MIE microphone of the contralateral hearing device.

In one or more examples, the binaural gain also denoted first gain is given as

$$G = \frac{\vert V \vert}{\sqrt{max ( {P}_{r ,} {P}_{l} )}} ,$$

where G is the binaural gain, V is the binaural beamform signal, and Pᵣ is a power of the contralateral input signal, and P_{I} is a power of the microphone input signal. Thereby, ILD's are not distorted by the binaural beamforming which in turn leads to preservation of spatial cues.

In one or more example hearing devices, the binaural beamform signal V is given by:

V=F_{L}H+F_{R}(1−H),

where F_{L} is the spectrum of the microphone input signal, F_{R} is the spectrum of the contralateral input signal, and H is a binaural transfer function. In one or more examples, the binaural beamform signal is a combination of the microphone input signal and the contralateral input signal. In one or more examples, F_{L} and F_{R} are frequency-domain signals. In one or more examples, H is a frequency-domain transfer function. In one or more examples, H is an equalization filter. In one or more example hearing devices, H satisfies 0<H≤1, such as 0<H<1.

In one or more examples, the disclosed techniques are implemented in frequency domain with short-time Fourier transforms. In one or more examples, the microphone input signal(s) from microphone(s) and/or the contralateral input signal are transformed in pre-processor into a time-frequency (T-F) representation, the T-F representation comprising T-F units, each one corresponding to a time and a frequency. In other words, the present disclosure may comprise applying a T-F masking techniques to the directional input signal and the contralateral directional input signal.

In one or more examples, the binaural gain G is a function of frequency. The binaural gain may be a bin-specific binaural gain. In other words, the binaural gain may comprise a first binaural gain for a first frequency bin and a second binaural gain for a second frequency bin. Thus, the binaural gain may be a gain vector comprising a plurality of gain coefficients, such as 4, 8, 16, 32, or 64 gain coefficients.

In one or more examples, the power Pᵣ of the contralateral input signal is given as:

Pᵣ(ω,n+1)=γPr(ω,n)+(1−γ)F_{R}(ω,n)F_{R}*(ω,n),

where 0≤γ<1 and F_{R} is spectrum of the contralateral input signal. ω=2πf is an angular frequency, and n is an integer to indicate frame index. The frequency f may be in the range from 0 to 20 KHz.

In one or more examples, the parameter γ for the power Pᵣ is zero.

In one or more examples, the parameter γ for the power Pᵣ is in the range from 0.2 to 0.3.

In one or more examples, the power Pᵢ of the microphone input signal is given as:

Pₗ(ω,n+1)=γPₗ(ω,n)+(1−γ)F_{L}(ω,n)F_{L}*(ω,n),

where 0≤γ<1 and F_{L} is spectrum of the microphone input signal. ω=2If is an angular frequency, and n is an integer to indicate frame index. The frequency f may be in the range from 0 to 20 KHz.

In one or more examples, the parameter γ for the power Pₗ is in the range from 0.2 to 0.3. The parameter γ for the powers Pₗ and Pᵣ may be the same.

In one or more examples, the gain controller, such as the gain estimator, is configured to determine a second gain, e.g. based on the microphone input signal; and determine a total gain based on the binaural gain as a first gain and the second gain. The processor may be configured to process the microphone input signal or secondary microphone input signal based on the total gain for provision of the electrical output signal. In other words, the gain estimator may be configured to determine a plurality of gains and optionally combine the plurality of gains to a total gain. The control signal output from the gain controller may be representative of or based on the total gain. The second gain may be hearing loss compensation gain. The second gain may be Automatic Gain Control (AGC) gain. The second gain may be a noise suppression gain. The second gain may be a feedback cancellation gain. The total gain may be a sum of gains in Log domain.

In one or more examples, the set of microphones comprises a first microphone for provision of a first microphone input signal, and a second microphone for provision of a second microphone input signal, the hearing device comprising a pre-processor configured to process the first microphone input signal and the second microphone input signal for provision of the microphone input signal.

In one or more examples, the pre-processor comprises a beamformer also denoted monaural beamformer configured for provision of a beamform output signal based on the first microphone input signal and the second microphone input signal, wherein the microphone input signal is based on the beamform output signal. In other words, the beamform output signal from the monaural may be fed as the microphone input signal to the binaural beamformer and the (first) power estimator.

The pre-processor may comprise a filterbank, such as an FFT filterbank, and/or a beamformer also denoted monaural beamformer. The filterbank is configured to filter/transform first microphone input signal, second microphone signal, and third microphone input signal if present, to respective multiband signals in the frequency domain. The pre-processor may be configured to provide or output the microphone input signal and optionally a secondary microphone input signal, e.g. where the microphone input signal is used to determine the binaural gain and the secondary microphone signal is processed, e.g. hearing compensated, based on the binaural gain for provision of the electrical output signal.

A method of operating a hearing device for a binaural hearing system comprising the hearing device and a contralateral hearing device is disclosed, the method comprising receiving contralateral data from the contralateral hearing device, the contralateral data comprising a contralateral input signal; providing, from a set of microphones of the hearing device, a microphone input signal; providing, with a binaural beamformer of the hearing device, a binaural beamform signal based on the microphone input signal and the contralateral input signal; processing the microphone input signal and the binaural beamform signal for provision of an electrical output signal; and converting the electrical output signal to an audio output signal, wherein processing the microphone input signal and the binaural beamform signal comprises estimating a maximum power of a power of the contralateral input signal and the microphone input signal; providing a binaural gain based on the binaural beamform signal and the maximum power; and providing the electrical output signal based on the binaural gain.

It is noted that descriptions and features of hearing device functionality, such as hearing device/processor configured to, also apply to methods and vice versa. For example, a description of a hearing device or processor configured to determine also applies to a method, e.g. of operating a hearing device, wherein the method comprises determining and vice versa.

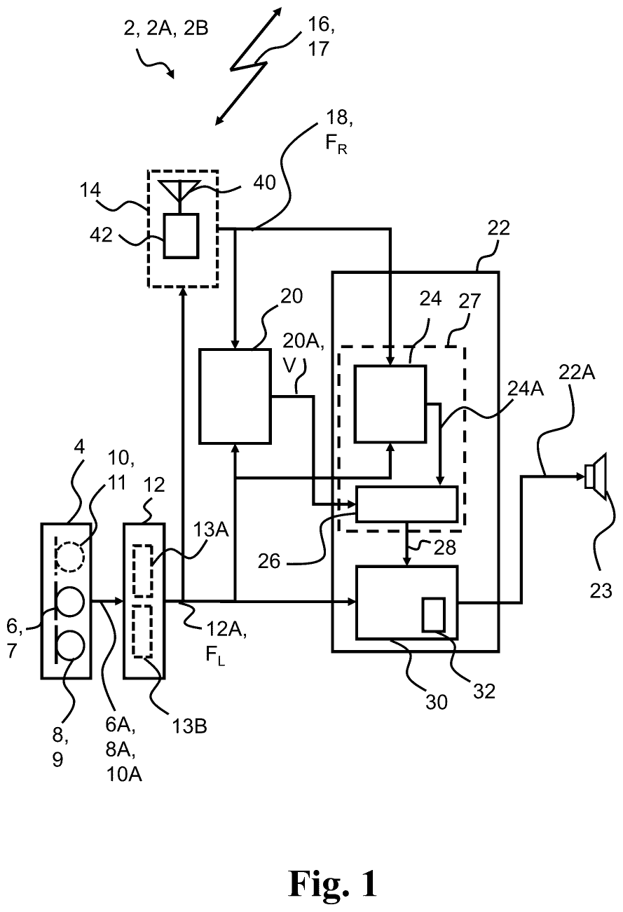

FIG. 1 shows an example hearing device 2, such as a first hearing device 2A and/or a second hearing device 2B, according to this disclosure. In one or more examples, the first hearing device 2A is an ipsilateral hearing device. In one or more examples, the second hearing device 2B is a contralateral hearing device.

The hearing device 2 comprises a set 4 of microphones including a first microphone 6 for provision of a first microphone input signal 6A, a second microphone 8 for provision of a second microphone input signal 8A, and optionally a third microphone 10 for provision of a third microphone input signal 10A. The hearing device 2 comprises a pre-processor 12 for pre-processing microphone input signals 6A, 8A, 10A to microphone input signal 12A, such as spectrum F_{L} of microphone input signal. The pre-processor 12 comprises a filterbank 13A and a monaural beamformer 13B for provision of a directional microphone input signal as microphone input signal 12A with spectrum F_{L} based on the first microphone input signal 6A from first microphone 6, such as first BTE microphone 7, and the second microphone input signal 8A from second microphone 8, such as second BTE microphone 9, as illustrated in FIG. 1.

The hearing device 2 comprises a transceiver module 14 for wired or wireless (as illustrated) communication with a contralateral hearing device, e.g. hearing device 2B. The transceiver module 14 comprises antenna 40 and radio transceiver 42 and is configured to receive contralateral data 16 from the contralateral hearing device, the contralateral data 16 comprising or being representative of a contralateral input signal 18, such as spectrum F_{R} of contralateral input signal. The transceiver module 14 is configured to transmit ipsilateral data 17 to the contralateral hearing device, the ipsilateral data 17 comprising or being representative of the microphone input signal 12A, such as spectrum F_{L} of the microphone input signal.

The hearing device 2 comprises a binaural beamformer 20 connected to, via pre-processor 12, the set of microphones and to the transceiver module 14 for provision of a binaural beamform signal 20A, V based on the microphone input signal 12A and the contralateral input signal 18. The microphone input signal 12A and the contralateral input signal 18 are fed as input to the binaural beamformer 20 configured to beamform the two signals 12A, 18 for provision of binaural beamform signal 20A also denoted V.

The hearing device 2 comprises a processor 22 configured to provide an electrical output signal 22A based on the microphone input signal 12A and the binaural beamform signal 20A; and a receiver 23 for converting the electrical output signal 22A to an audio output signal.

The processor 22 comprises a (first) power estimator 24 for provision of a maximum power 24A of a power of the contralateral input signal and the microphone input signal; and a gain estimator 26 for provision of a binaural gain not shown here but otherwise referred to with reference 26A based on the binaural beamform signal 20A and the maximum power 24A.

A gain controller 27 implements one or more power estimators including first power estimator 24 and gain estimator 26. The contralateral input signal 18 and the microphone input signal 12A are fed to the (first) power estimator 24 for provision of a maximum power 24A of input signals 12A and 18. The maximum power 24A and the binaural beamform signal 20A are fed to gain estimator 26 configured to determine a binaural gain based on the binaural beamform signal 20A and the maximum power 24A.

The binaural gain is given as

$$G = \frac{\vert V \vert}{\sqrt{max ( {P}_{r ,} {P}_{l} )}} ,$$

where G is the binaural gain, V is the binaural beamform signal 20A, and Pᵣ is a power of the contralateral input signal 18, and P_{I} is a power of the microphone input signal 12A.

A control signal 28 based on or representative of the binaural gain is output to hearing compensation circuitry and controls hearing compensation processing 30, such as compressor circuitry 32, for provision of the electrical output signal 22A based on the binaural gain.

In one or more examples, the gain estimator 26 is configured to determine a second gain based on one or more of microphone input signal 12A, contralateral input signal 18, and binaural beamform signal 20A; and determine a total gain based on the binaural gain as a first gain and the second gain, wherein the processor 22 is configured to process the microphone input signal 12A based on the total gain for provision of the electrical output signal 22A. Thus, control signal 28 based on or representative of the total gain (sum of first gain and second gain in the Log domain) may be output to hearing compensation circuitry and control hearing compensation processing 30, such as compressor circuitry 32, for provision of the electrical output signal 22A based on the total gain and therefore the binaural gain. In other words, the hearing compensation circuitry, such as compressor circuitry 32 may be configured to apply the binaural gain or total gain based on the binaural gain to the microphone input signal 12A.

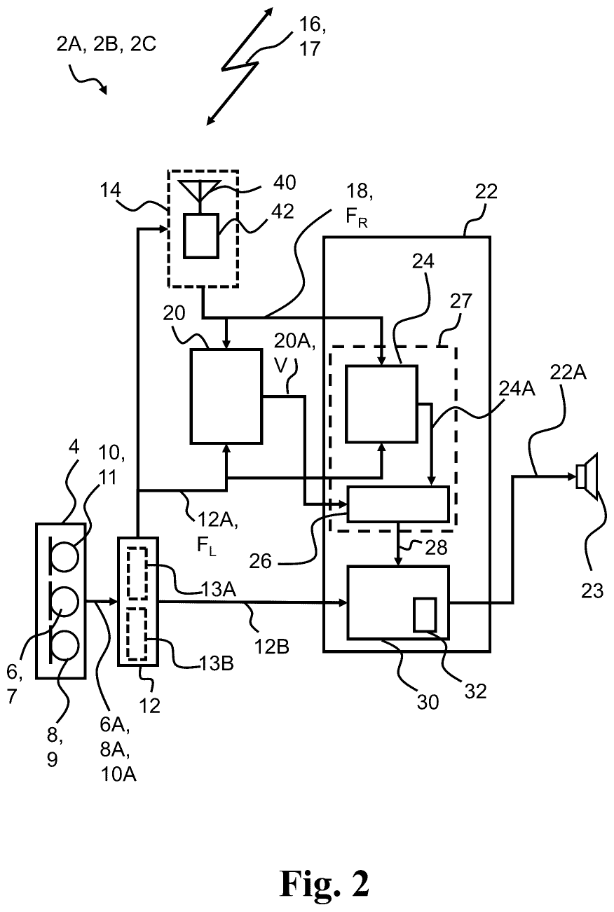

FIG. 2 shows an example hearing device 2C, such as a first hearing device 2A and/or a second hearing device 2B, according to this disclosure. In one or more examples, the first hearing device 2A is an ipsilateral hearing device. In one or more examples, the second hearing device 2B is a contralateral hearing device.

The hearing device 2 comprises a set 4 of microphones including a first microphone 6 for provision of a first microphone input signal 6A, a second microphone 8 for provision of a second microphone input signal 8A, and a third microphone 10 for provision of a third microphone input signal 10A. The hearing device 2 comprises a pre-processor 12 for pre-processing microphone input signals 6A and 8A to a secondary microphone input signal 12B and pre-processing the third microphone input signal 10A to microphone input signal 12A, such as spectrum F_{L} of microphone input signal. The pre-processor 12 comprises a filterbank 13A and a monaural beamformer 13B for provision of a directional microphone input signal as the secondary microphone input signal 12B based on the first microphone input signal 6A from first microphone 6, such as first BTE microphone 7, and the second microphone input signal 8A from second microphone 8, such as second BTE microphone 9. The filterbank 13A of pre-processor 12 in FIG. 2 is configured for provision of the third microphone input signal 10A from the third microphone 10, such as MIE microphone 11 as illustrated in FIG. 2. It is to be noted that the pre-processor 12 may be configured to adaptively combine microphone input signals 6A, 8A, 10A for provision of the secondary microphone input signal 12B.

The hearing device 2 comprises a processor 22 configured to provide an electrical output signal 22A based on the microphone input signal 12A, the secondary microphone input signal 12B, and the binaural beamform signal 20A; and a receiver 23 for converting the electrical output signal 22A to an audio output signal.

Control signal 28 from gain estimator 26/gain controller 27 is output to hearing compensation circuitry and control hearing compensation processing 30, such as compressor circuitry 32, for provision of the electrical output signal 22A based on the binary gain and optionally total gain. In other words, the hearing compensation circuitry, such as compressor circuitry 32 may be configured to apply the binaural gain or total gain based on the binaural gain to the secondary microphone input signal 12B for provision of the electrical output signal 22A. Thus, control signal 28 based on or representative of the binary gain and optionally total gain (sum of first gain and second gain in the Log domain) may be output to hearing compensation circuitry and control hearing compensation processing 30, such as compressor circuitry 32, for provision of the electrical output signal 22A based on the binary gain and optionally total gain.

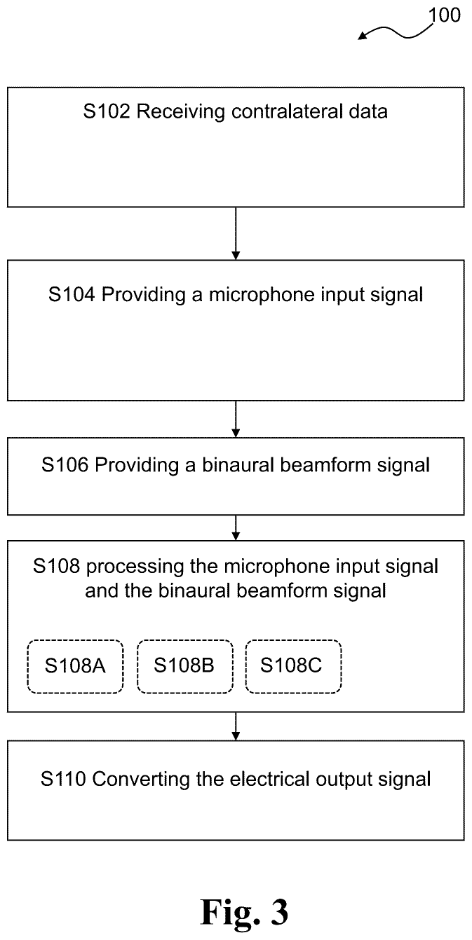

FIG. 3 shows a flowchart of an example method of operating a hearing device, such as hearing device 2, 2A, 2B, 2C for a binaural hearing system comprising the hearing device and a contralateral hearing device. The method 100 comprises receiving S102 contralateral data from the contralateral hearing device, the contralateral data comprising a contralateral input signal; providing S104, from a set of microphones of the hearing device, a microphone input signal; providing S106, with a binaural beamformer of the hearing device, a binaural beamform signal based on the microphone input signal and the contralateral input signal; processing S108 the microphone input signal and the binaural beamform signal for provision of an electrical output signal; and converting S110 the electrical output signal to an audio output signal, wherein processing S108 the microphone input signal and the binaural beamform signal comprises estimating S108A a maximum power of a power of the contralateral input signal and the microphone input signal; providing S108B a binaural gain based on the binaural beamform signal and the maximum power; and providing S108C the electrical output signal based on the binaural gain.

Also disclosed are hearing devices, hearing systems, and methods according to any of the following items.

Item 1. A hearing device for a binaural hearing system, the hearing device comprising:
a transceiver module for communication with a contralateral hearing device of the binaural system, the transceiver module configured to receive contralateral data from the contralateral hearing device, the contralateral data comprising a contralateral input signal;
a set of microphones for provision of a microphone input signal;
a binaural beamformer connected to the set of microphones and the transceiver module for provision of a binaural beamform signal based on the microphone input signal and the contralateral input signal;
a processor configured to provide an electrical output signal based on the microphone input signal and the binaural beamform signal; and
a receiver for converting the electrical output signal to an audio output signal, wherein the processor comprises:
a power estimator for provision of a maximum power of a power of the contralateral input signal and the microphone input signal; and
a gain estimator for provision of a binaural gain based on the binaural beamform signal and the maximum power,
   wherein the electrical output signal is based on the binaural gain.

Item 2. Hearing device according to Item 1, wherein the binaural gain is given as

$$G = \frac{\vert V \vert}{\sqrt{max ( {P}_{r ,} {P}_{l} )}} ,$$

where G is the binaural gain, V is the binaural beamform signal, and Pᵣ is a power of the contralateral input signal, and P_{I} is a power of the microphone input signal.

Item 3. Hearing device according to Item 2, wherein the binaural gain G is a function of frequency.

Item 4. Hearing device according to any one of Items 1-3, wherein the power Pᵣ of the contralateral input signal is given as:

Pᵣ(ω,n+1)=γPᵣ(ω,n)+(1−γ)F_{R}(ω,n)F_{R}*(ω,n),

where 0≤γ<1 and F_{R} is spectrum of the contralateral input signal.

Item 5. Hearing device according to Item 4, wherein the parameter γ is in the range from 0.2 to 0.3.

Item 6. Hearing device according to any one of Items 1-5, wherein the power Pₗ of the microphone input signal is given as:

Pᵣ(ω,n+1)=γPₗ(ω,n)+(1−γ)F_{L}(ω,n)F_{L}*(ω,n),

where 0≤γ<1 and F_{L} is spectrum of the microphone input signal.

Item 7. Hearing device according to Item 6, wherein the parameter γ is in the range from 0.2 to 0.3.

Item 8. Hearing device according to any one of Items 1-7, wherein the gain estimator is configured to:
determine a second gain based on the microphone input signal; and
determine a total gain based on the binaural gain as a first gain and the second gain,
   wherein the processor is configured to process the microphone input signal based on the total gain for provision of the electrical output signal.

Item 9. Hearing device according to any one of Items 1-8, wherein the set of microphones comprises a first microphone for provision of a first microphone input signal, and a second microphone for provision of a second microphone input signal, the hearing device comprising a pre-processor configured to process the first microphone input signal and the second microphone input signal for provision of the microphone input signal.

Item 10. Hearing device according to Item 9, wherein the pre-processor comprises a beamformer configured for provision of a beamform output signal based on the first microphone input signal and the second microphone input signal, wherein the microphone input signal is based on the beamform output signal.

Item 11. Hearing device according to any one of Items 1-10, wherein the binaural beamformer is an adaptive beamformer.

Item 12. Hearing system comprising a first hearing device and a second hearing device, wherein the first hearing device is a hearing device according to any one of Items 1-11, and the second hearing device is a hearing device according to any one of Items 1-11.

Item 13. Method of operating a hearing device for a binaural hearing system comprising the hearing device and a contralateral hearing device, the method comprising:
receiving contralateral data from the contralateral hearing device, the contralateral data comprising a contralateral input signal;
providing, from a set of microphones of the hearing device, a microphone input signal;
providing, with a binaural beamformer of the hearing device, a binaural beamform signal based on the microphone input signal and the contralateral input signal;
processing the microphone input signal and the binaural beamform signal for provision of an electrical output signal; and
converting the electrical output signal to an audio output signal,
   wherein processing the microphone input signal and the binaural beamform signal comprises:
estimating a maximum power of a power of the contralateral input signal and the microphone input signal;
providing a binaural gain based on the binaural beamform signal and the maximum power; and
providing the electrical output signal based on the binaural gain.

Item 14. Method according to Item 13, wherein the hearing device is a hearing device according to any one of Items 1-11.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that the figures comprise some elements, circuitries or operations which are illustrated with a solid line and some circuitries or operations which are illustrated with a dashed line. Circuitries or operations which are comprised in a solid line are circuitries or operations which are comprised in the broadest example embodiment. Circuitries or operations which are comprised in a dashed line are example embodiments which may be comprised in, or a part of, or are further circuitries or operations which may be taken in addition to circuitries or operations of the solid line example embodiments. It should be appreciated that these operations need not be performed in order presented. Furthermore, it should be appreciated that not all of the operations need to be performed. The example operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It is to be noted that the term “indicative of” may be seen as “associated with”, “related to”, “descriptive of”, “characterizing”, and/or “defining”. The terms “indicative of”, “associated with”, “related to”, “descriptive of”, “characterizing”, and “defining” can be used interchangeably. The term “indicative of” can be seen as indicating a relation. For example, weight data indicative of weight may comprise one or more weight parameters.

It is to be noted that the word “based on” may be seen as “as a function of” and/or “derived from”. The terms “based on” and “as a function of” can be used interchangeably. For example, a parameter determined “based on” a data set can be seen as a parameter determined “as a function of” the data set. In other words, the parameter may be an output of one or more functions with the data set as an input.

A function may be characterizing a relation between an input and an output, such as mathematical relation, a database relation, a hardware relation, logical relation, and/or other suitable relations.

It should further be noted that any reference signs do not limit the scope of the claims, that the example embodiments may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

### LIST OF REFERENCES

2, 2C hearing device
2A first hearing device
2B second hearing device
4 set of microphones
6 first microphone
6A first microphone input signal
7 first BTE microphone
8 second microphone
8A second microphone input signal
9 second BTE microphone
10 third microphone
10A third microphone input signal
11 MIE microphone
12 pre-processor
12A microphone input signal, primary microphone input signal
12B secondary microphone input signal
13A filterbank
13B monaural beamformer
14 transceiver module
16 contralateral data
17 ipsilateral data
18 contralateral input signal
20 binaural beamformer
22 processor/processing unit
22A electrical output signal
23 receiver
24 power estimator, first power estimator
24A maximum power of a power of the contralateral input signal and the microphone input signal
26 gain estimator
27 gain controller
28 control signal
30 hearing compensation processing
32 compressor circuitry
40 antenna
42 radio transceiver
100 method of operating a hearing device for a binaural hearing system
S102 receiving contralateral data from the contralateral hearing device
S104 providing, from a set of microphones of the hearing device, a microphone input signal
S106 providing, with a binaural beamformer of the hearing device, a binaural beamform signal based on the microphone input signal and the contralateral input signal
S108 processing the microphone input signal and the binaural beamform signal for provision of an electrical output signal
S108A estimating a maximum power of a power of the contralateral input signal and the microphone input signal
S108B providing a binaural gain based on the binaural beamform signal and the maximum power
S108C providing the electrical output signal based on the binaural gain
S110 converting the electrical output signal to an audio output signal

1. A hearing device for a binaural hearing system, the hearing device comprising:
a transceiver module configured to communicate with a contralateral hearing device of the binaural system, the transceiver module configured to receive contralateral data from the contralateral hearing device, the contralateral data comprising a contralateral input signal;
a set of microphones;
a binaural beamformer configured to provide a binaural beamform signal based on a microphone input signal and the contralateral input signal, wherein the microphone input signal is associated with the microphones;
a processor configured to provide an electrical output signal based on the microphone input signal and the binaural beamform signal; and
a receiver configured to provide an audio output signal based on the electrical output signal;
wherein the processor comprises:
a power estimator for provision of a maximum power, wherein the maximum power is a maximum of (1) a power of the contralateral input signal and (2) a power of the microphone input signal; and
a gain estimator for provision of a binaural gain based on the binaural beamform signal and the maximum power; and
wherein the electrical output signal is based on the binaural gain.

2. The hearing device according to claim 1, wherein the binaural gain is given as
$$G = \frac{\vert V \vert}{\sqrt{max ( {P}_{r ,} {P}_{l} )}} ,$$
where G is the binaural gain, V is the binaural beamform signal, and Pᵣ is the power of the contralateral input signal, and P_{I} is the power of the microphone input signal.

3. The hearing device according to claim 1, wherein the binaural gain is a function of frequency.

4. The hearing device according to claim 1, wherein the power of the contralateral input signal is given as:
Pᵣ(ω,n+1)=γPᵣ(ω,n)+(1−γ)F_{R}(ω,n)F_{R}*(ω,n),
wherein γ is a parameter, 0≤γ<1, and F_{R} is a spectrum of the contralateral input signal.

5. The hearing device according to claim 4, wherein the parameter γ is anywhere from 0.2 to 0.3.

6. The hearing device according to claim 1, wherein the power of the microphone input signal is given as:
Pₗ(ω,n+1)=γPₗ(ω,n)+(1−γ)F_{L}(ω,n)F_{L}*(ω,n),
wherein γ is a parameter, 0≤γ<1, and F_{L} is spectrum of the microphone input signal.

7. The hearing device according to claim 6, wherein the parameter γ is anywhere from 0.2 to 0.3.

8. The hearing device according to claim 1, wherein the binaural gain is a first gain, and wherein the gain estimator is configured to:
determine a second gain based on the microphone input signal; and
determine a total gain based on the first gain and the second gain;
wherein the processor is configured to process the microphone input signal based on the total gain for provision of the electrical output signal.

9. The hearing device according to claim 1, wherein the set of microphones comprises a first microphone for provision of a first microphone input signal, and a second microphone for provision of a second microphone input signal, the hearing device comprising a pre-processor configured to process the first microphone input signal and the second microphone input signal for provision of the microphone input signal.

10. The hearing device according to claim 9, wherein the pre-processor comprises a beamformer configured for provision of a beamform output signal based on the first microphone input signal and the second microphone input signal, wherein the microphone input signal is based on the beamform output signal.

11. The hearing device according to claim 1, wherein the binaural beamformer is an adaptive beamformer.

12. The hearing device according to claim 1, wherein the binaural gain is a function of a square root of the maximum power.

13. The hearing device according to claim 1, wherein the binaural gain is inversely proportional to the square root of the maximum power.

14. The hearing device according to claim 1, wherein the binaural beamformer is coupled with the set of microphones and the transceiver module.

15. A hearing system comprising the hearing device of claim 1 and the contralateral hearing device.

16. A method performed by a hearing device of a binaural hearing system, the binaural hearing system comprising the hearing device and a contralateral hearing device, the method comprising:
receiving contralateral data from the contralateral hearing device, the contralateral data comprising a contralateral input signal;
providing a microphone input signal, wherein the microphone input signal is associated with a set of microphones;
providing, by a binaural beamformer of the hearing device, a binaural beamform signal based on the microphone input signal and the contralateral input signal;
processing the microphone input signal and the binaural beamform signal for provision of an electrical output signal; and
providing an audio output signal based on the electrical output signal;
wherein the act of processing the microphone input signal and the binaural beamform signal comprises:
estimating a maximum power as a maximum of (1) a power of the contralateral input signal and (2) a power of the microphone input signal; and
providing a binaural gain based on the binaural beamform signal and the maximum power; and
wherein the electrical output signal is based on the binaural gain.

17. The method according to claim 16, wherein the hearing device comprises:
a transceiver module configured to communicate with the contralateral hearing device, the transceiver module configured to receive the contralateral data from the contralateral hearing device;
the set of microphones;
the binaural beamformer;
a processor configured to provide the electrical output signal based on the microphone input signal and the binaural beamform signal; and
a receiver configured to provide the audio output signal based on the electrical output signal;
wherein the processor comprises:
a power estimator configured to estimate the maximum power; and
a gain estimator configured to provision the binaural gain based on the binaural beamform signal and the maximum power.

18. The method according to claim 16, wherein the binaural gain is a function of a square root of the maximum power.

19. The method according to claim 16, wherein the binaural gain is inversely proportional to the square root of the maximum power.
